(19) United States
(12) Patent Application Publication
(10) Pub. No.: US 2009/0239485 A1
(43) Pub. Date: Sep. 24, 2009

(54) PROCESS DATA TRANSMITTER WITH WIRELESS CAPABILITY

(75) Inventor: Mark Allen Woodmansee, Minden, NV (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 12/053,909

(22) Filed: Mar. 24, 2008

(51) Int. Cl. H04B 1/02; H04B 1/06

(52) U.S. Cl. 455/91; 455/130

(57) ABSTRACT

Disclosed is a data transmitter for equipment monitoring including a data input portion capable of receiving data from at least one measurement sensor and a data storage portion capable of storing data received by the data input section. An output portion is capable of outputting data as electric current via an electrical wire, and a radio transmitter is capable of outputting data as a radio signal. A method for collecting data from at least one piece of machinery includes receiving data from at least one measurement sensor in operable communication with the at least one piece of machinery and storing the data in a data storage portion. At least a portion of the data is output as electric current via an electrical wire, and at least a portion of the data is output as a radio signal via a radio transmitter.

### BACKGROUND

The subject invention relates to industrial machinery. More particularly, the subject invention relates to collection and storage of process data from industrial machinery.

At least two types of data are typically collected from industrial machinery which may be situated, for example, in an electrical power plant, petro-chemical plant, or utility operation. A first type is static data, or processed trend data which often includes pressure, temperature, humidity, and/or vibration characteristics measured by sensors located at one or more points on or near the machine. This data is periodically measured and fed to a transmitter located at the machine. The transmitter converts the data to an electric current and sends the data to a process controller or plant distributed control system (DCS) via a wired connection.

A second type of data is dynamic data collected by machine operators during periodic walk-arounds. During these walk-arounds, the machine operators typically approach each energized machine to read gauges on the machine and/or take additional measurements by touching the machine with a mechanical probe to record temperature, vibration, and/or other parameters. The data collected by the machine operators is often recorded in a personal data assistant, in a portable data collector, or in a paper notebook. The walk-arounds may vary in frequency from more than one per day to less than one per month.

### BRIEF DESCRIPTION OF THE INVENTION

The present invention solves the aforementioned problems by providing a data transmitter for equipment monitoring including a data input portion capable of receiving data from at least one measurement sensor and a data storage portion capable of storing data received by the data input section. An output portion is capable of outputting data as electric current via an electrical wire, and a radio transmitter is capable of outputting data as a wireless radio signal.

A method for collecting data from at least one piece of machinery includes receiving data from at least one measurement sensor in operable communication with the at least one piece of machinery and storing the data in a data storage portion. At least a portion of the data is output as electric current via an electrical wire, and at least a portion of the data is output as a radio signal via a radio transmitter.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic of a data transmitter; and

FIG. 2 is an illustration of a plant layout utilizing one or more data transmitters of FIG. 1.

The detailed description explains embodiments of the invention, together with advantages and features, by way of example with reference to the drawings.

### DETAILED DESCRIPTION OF THE INVENTION

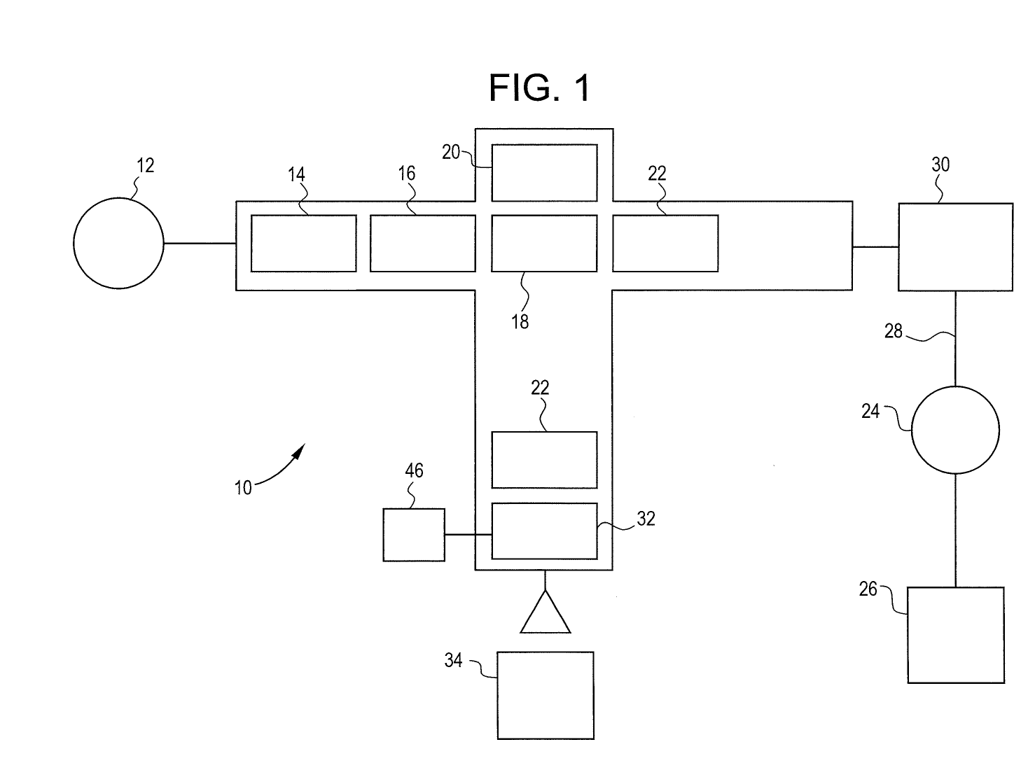

Shown in FIG. 1 is a schematic of an embodiment of a data transmitter 10. The data transmitter 10 is capable of transmitting data both wirelessly and via a wired connection. The data transmitter 10 is operably connected to at least one sensor 12. The sensor 12 is configured to provide data to the data transmitter 10, for example, vibration, temperature, pressure, and/or humidity, at a rate of, for example 120 samples per second or below for normal data collection. The data may be filtered by an input filter 14, and data from analog sensors (not shown) may, in some embodiments, be converted into digital form utilizing an analog to digital converter (ADC) 16. If desired, the digitally-converted data is processed via a microprocessor unit (MPU) 18 to transform, for example, vibration measurements into peak-to-peak vibration data, temperature measurements into an average temperature, humidity measurements into average humidity, and/or other data. The data transmitter 10 further includes data storage capabilities, for example, flash memory 20. Flash memory 20 may be utilized to store quantities of data processed by the MPU 18 and/or raw data from the sensors 12.

Data is output from the data transmitter 10 in two ways. First, the data may be converted from digital form to analog form via a digital to analog converter (DAC) 22 and outputted to an analog input module (AIM) 24 of, for example, a distributed control system (DCS) 26 via a wired pathway 28. The wired pathway 28 may include, for example, a 4-20 mA transmitter 30. Second, the data may be converted from digital form to analog form by the DAC 22 and transmitted via a wireless radio 32 to a wireless communications device 34. The wireless communications device 34 may be a personal data assistant, personal data collector, cellular phone, laptop computer, or the like. These devices, however, are merely listed as examples, and it is to be appreciated that other wireless communications devices 34 are contemplated within the present scope.

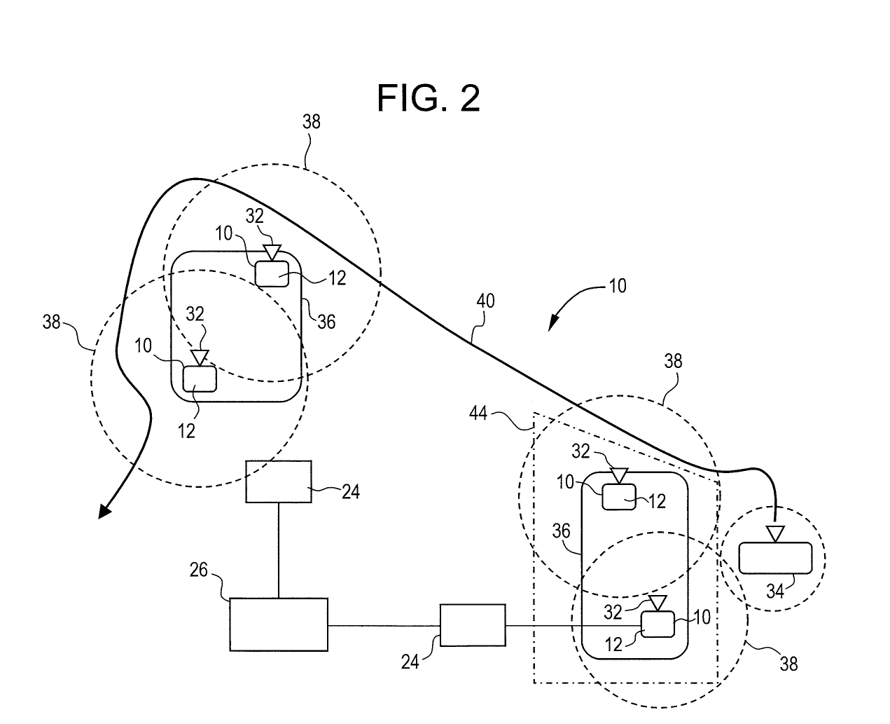

FIG. 2 illustrates a typical facility layout including one or more machines 36 that are monitored for at least one type of process and/or environmental data. At least one data transmitter 10 is operably connected to each machine 36 from which data is to be collected. The data transmitter 10 is configured to transmit static and/or processed data collected from one or more sensors 12 which are in operable communication with the machine 36. The sensors 12 may measure, for example, vibration, temperature, and/or humidity, which may be processed by the MPU 18 into, for example, vibration peak-to-peak, average temperature, and/or average humidity. In some embodiments, the static and/or processed data may be stored in the flash memory 20. The static and/or processed data is transmitted from the data transmitter 10 to an AIM 24 which then provides the static and/or processed data to the plant DCS 26 via the wired pathway 28.

The data transmitter 10 is additionally configured to transmit dynamic data. The dynamic data or real-time data may include, for example, dynamic waveforms, vibration spectra, pressure oscillations, and/or acoustic spectra collected by the at least one sensor 12. This dynamic data may be additionally stored in the data transmitter 10 in flash memory 20. Collection of this data from the data transmitter 10 is accomplished through periodic walk-arounds by a machine operator or other personnel or means. The machine operator follows a walk-around path 40. The path shown is merely exemplary and other paths are contemplated within the current scope. When the machine operator moves within a transmission range 38 of the data transmitter 10, the dynamic data is transmitted from the data transmitter 10 by the wireless radio 32 to the wireless communications device 34 in the operator's possession. Collection of dynamic data wirelessly via the data transmitter 10 and the wireless communications device 34 allows the dynamic data to be collected without physically touching the machine 36 with a probe or other device. In this way, walk-arounds and collection of dynamic data can be completed more quickly and more safely. For instance, a data transmitter 10 located in a hazardous area 44 may utilize an increased signal strength to extend its transmission range 38 into the walk-around path 40 located outside of the hazardous area 44. Collection of data in this manner also reduces human error in the collection of data, for example, error which may occur when obtaining measurements via a handheld probe, or error that may occur when recording measurements in a notebook or through keyboard, touchpad or, touchscreen entry in a handheld electronic device.

The data transmitter 10 may be further configured to store and transmit event-triggered data. Events may occur when one or more data parameters reach or exceed a predetermined alarm level, or in other instances mown to those skilled in the art. When an event occurs, the data transmitter 10 begins collecting data at a high rate, for example, up to 100,000 samples per second and stores the data in the flash memory 20 of the data transmitter 10. The data collection at a high rate continues until the data parameters return to levels not reaching or exceeding the alarm level. This event-triggered data is stored in the data transmitter 10 to be transmitted to the machine operator during a walk-around. If the event leads to failure of the machine 36, the data may be collected from the data transmitter 10 during post-mortem analysis of the machine 36.

In some embodiments, the wireless radio 32 may be powered by the same 4-20 mA 12/24V circuitry that powers the transmitter 30. Use of this circuitry reduces power consumption of the wireless radio 32.

Referring again to FIG. 1, in some embodiments, the data transmitter 10 may be programmed remotely by the wireless communications device 34. The wireless communications device 34 may transmit signals to the data transmitter 10 which are received by the wireless radio 32 to, for example, initialize the data transmitter 10 and/or set or change data collection parameters such as frequency, or type of data to be collected, stored, processed, and/or transmitted by the data transmitter 10. For example, remote programming may be used to establish or modify a full-scale range, a zero point, and/or an ID number of the data transmitter 10.

In some embodiments, data stored in the data transmitter 10 may be protected from tampering and/or unauthorized retrieval in one or more ways. The data may be protected, for example, by an encryption such as wireless encryption protocol (WEP) and/or physical lockout of the wireless radio 32 with a tab or switch 46 on the wireless radio 32. The switch 46 may be unlocked by the machine operator during the walk-around to allow for retrieval of the data from the data transmitter 10. In another embodiment, data in the data transmitter 10 may be secured through the use of lock/unlock codes that are transmitted from the DCS 26 to the data transmitter 10 via the wired pathway 28. The DCS 26 may transmit an unlock code to the data transmitter 10 to allow access to the data in the data transmitter 10 during, for example, a walk-around, and may transmit a lock code to the data transmitter 10 to secure the data transmitter 10 once a walk-around is completed.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A data transmitter for equipment monitoring comprising:
a data input portion capable of receiving data from at least one measurement sensor;
a data storage portion capable of storing data received by the data input section;
an output portion capable of outputting data from the data transmitter as electric current via an electrical wire; and
a radio transmitter capable of outputting data from the data transmitter as a radio signal.

2. The data transmitter of claim 1 including at least one analog to digital converter for translating data received from the at least one measurement sensor from an analog signal to a digital signal.

3. The data transmitter of claim 1 including at least one data processing portion for performing calculations on data received by the data input section.

4. The data transmitter of claim 3 wherein the at least one data processing portion includes at least one microprocessor unit.

5. The data transmitter of claim 4 including at least one digital to analog converter for translating data processed by the microprocessor unit into an analog signal.

6. The data transmitter of claim 1 wherein the output portion includes a 4-20 mA transmitter powered by 12/24 V circuitry.

7. The data transmitter of claim 6 wherein the radio transmitter is powered by the 12/24 V circuitry.

8. The data transmitter of claim 1 wherein the radio transmitter includes a switch for preventing unauthorized retrieval of data from the data transmitter.

9. The data transmitter of claim 1 wherein the radio transmitter is capable of transmitting data to a wireless communication device.

10. The data transmitter of claim 9 wherein the wireless communication device is one of a personal data assistant, a personal data collector, a cellular phone, or a laptop computer.

11. The data transmitter of claim 9 wherein the data transmitter is programmable by the wireless communications device.

12. The data transmitter of claim 1 wherein the data input portion is capable of collecting event-triggered data at a rate of about 100,000 samples per second when one or more data parameters exceed a predetermined alarm level.

13. The data transmitter of claim 12 wherein the data storage portion is capable of storing the event-triggered data.

14. A method for collecting data from at least one piece of machinery comprising:
receiving data as from at least one measurement sensor in operable communication with the at least one piece of machinery;
storing the data in a data storage portion;
outputting at least a portion of the data as electric current via an electrical wire; and
outputting at least a portion of the data as a radio signal via a radio transmitter.

15. The method of claim 14 including converting at least a portion of the data received from the at least one measurement sensor from an analog signal to a digital signal.

16. The method of claim 14 including performing calculations on at least a portion of the data received from the at least one measurement sensor by at least one microprocessor unit.

17. The method of claim 16 including translating at least a portion of the data processed by the microprocessor unit into an analog signal.

18. The method of claim 14 wherein outputting at least a portion of the data as electric current via an electrical wire comprises transmitting the data via a wired pathway to a distributed control system.

19. The method of claim 14 including transmitting an electrical signal to the radio transmitter via the electrical wire to unlock the radio transmitter thereby allowing the radio transmitter to transmit.

20. The method of claim 19 including transmitting an electrical signal to the radio transmitter via the electrical wire to lock the radio transmitter thereby preventing the radio transmitter from transmitting.

21. The method of claim 14 including receiving the radio signal with a wireless communication device.

22. The method of claim 21 wherein the radio signal is received by the wireless communication device during a periodic walk-around.

23. The method of claim 21 wherein the wireless communication device is one of a personal data assistant, a personal data collector, a cellular phone, or a laptop computer.
